(19) United States
(12) Patent Application Publication
(10) Pub. No.: US 2014/0019366 A1
(43) Pub. Date: Jan. 16, 2014

(54) METHOD AND A SYSTEM FOR SECURING FINANCIAL TRANSACTION

(71) Applicants: Kiran Kannambadi, Bangalore (IN); Subbakrishna Ramsesh, Bangalore (IN)

(72) Inventors: Kiran Kannambadi, Bangalore (IN); Subbakrishna Ramsesh, Bangalore (IN)

(73) Assignee: Infosys Limited, Bangalore (IN)

(21) Appl. No.: 14/000,195

(22) PCT Filed: Mar. 31, 2011
(86) PCT No.: PCT/IN2011/000226

§ 371 Date: Aug. 16, 2013

(51) Int. Cl. G06Q 20/40

(52) U.S. Cl. CPC G06Q 20/4012
USPC 705/72; 705/64

(57) ABSTRACT

The present disclosure is related to a method for securing financial transaction. The method includes encrypting transaction information on a server 102 upon receipt of said information from a computing device 101. Encoding the encrypted transaction information into a predefined image pattern and transmitting the encoded image to the computing device 101. The method further includes scanning the image displayed on the computing device 101 from user's mobile device 103 to decode the scanned image and to decrypt the transaction information. The method also includes prompting the user upon successful decryption to enter Personal Identification Number (PIN) into the mobile device 103 to generate a unique signature. Finally, the user enters the signature on the computing device 101 for validation of said signature by the server 102 to secure the financial transaction.

### RELATED APPLICATION DATA

This application claims priority to International Patent Application No. PCT/IN2011/000226, filed Mar. 31, 2011, the disclosure of which is hereby incorporated by reference in its entirety.

### FIELD OF THE INVENTION

Embodiments of the present disclosure relate to secure financial transaction. More particularly, embodiments relate to generating a mobile based digital signature with image based transmission technique to secure financial transaction.

### BACKGROUND

For as long as people have conducted commerce, instances of financial fraud have always been there. Thus abuse of the existing financial systems is not uncommon. Financial fraud in this context includes currency counterfeit, credentials counterfeit, authorization fraud and identity theft.

While the methods of authentication and authorization have undergone various forms of improvements over the centuries, the current popular practices are easy to defeat. Currency counterfeit and credit card fraud cost the domestic financial industries billions of dollars every year and also creates stifle credit availability in the developing economies. Additionally, with the introduction of Internet-based commerce, enforcement is difficult to scale in proportion to the amount of frauds possible over internet.

The present day technology can be explained in two sections:

Firstly, the transactions are carried out using Digital Signature, which provides a mechanism of securing financial transactions by encrypting the transaction information at the client location, using security components issued by the trusted authorities. It works as follows. Certain characteristics of the transaction are captured from the browser form. These transaction characteristics are encrypted using an encryption algorithm. The encrypted transaction data and transaction data are posted to a server. The server encrypts the same characteristics of the transaction and compares it with the encrypted transaction data (from client). A successful comparison will ensure authenticity of the transaction information.

Secondly, the transactions are carried out using Two Factor Authentication and One-time password. In this model, a customer enters more than one piece of information to identify self during initiation of the transaction. This is normally coupled with a one-time password (OTP). The OTP is generated using a hardware token/key-fob device.

There exist limitations in both the approaches. For example, a digital signature is to be installed on the computer from where the financial transaction is initiated and hence mobility is affected. Further, the digital signature requires expensive infrastructure in the form of signature servers, and distribution of signatures. Also, the one time password infrastructure can only ensure protection against replay attacks. Hence, transaction information sanity cannot be ensured. In addition, Digital signature requires a component to be installed on the client computer for generating the transaction hash.

There are existing applications for generating signature on the mobile phone using transaction details which expects the customer to re-enter the transaction details or transmit the transaction information through an out of band mechanism such as SMS/USSD/WAP etc.

In light of the foregoing discussion, there is a need for a method and device to solve the above mentioned problems.

### SUMMARY

The shortcomings of the prior art are overcome and additional advantages are provided through the provision of a method and a system as described in the description.

Additional features and advantages are realized through various techniques provided in the present disclosure. Other embodiments and aspects of the disclosure are described in detail herein and are considered as part of the claimed disclosure.

The present disclosure solves the limitations of existing techniques by providing a method of generating an image based on the transaction details and scanning the image on the mobile phone. The image which contains the encrypted transaction data can be interpreted only by a valid application. In addition, the captured image will populate itself into a signature generation screen which will seek the customer input for Personal Identification Number (PIN) to generate the signature.

In one embodiment, the present disclosure provides a method for securing financial transaction. The method includes encrypting transaction information on a server 102 upon receipt of said information from a computing device 101. Further, the server 102 encodes the encrypted transaction information into a predefined image pattern and transmits the encoded image to the computing device 101. The method further includes scanning the image displayed on the computing device 101 from user's mobile device 103 to decode the scanned image and to decrypt the transaction information. Once, the decryption is successful, a mobile application stored in the computing device prompts the user to enter Personal Identification Number (PIN) into the mobile device 103 to generate an unique signature. Now, the user enters the generated signature on the computing device 101 for validation of said signature by the server 102 for the secured financial transaction.

In one embodiment, the present disclosure provides a system for securing financial transaction. The system includes a computing device 101 for transmitting transaction information to a server 102 and to receive the encoded image from the server 102. The server is 102 being configured to encrypt the transaction information and to encode the encrypted information into a predefined image pattern. The system also includes a mobile device 103 capable of scanning the image displayed on the computing device 101, wherein said mobile device 103 is configured to decode the scanned image and to decrypt the transaction information to generate an unique signature.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristic of the disclosure are set forth in the appended claims. The embodiments of the disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings wherein like reference numerals represent like elements and in which:

FIG. 1 is an exemplary block diagram of a system setup in accordance with an aspect of the subject disclosure for carrying out financial transactions securely.

FIG. 2 is a flowchart illustrating a method for securing financial transaction, in accordance with an exemplary embodiment.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present disclosure relate to Digital Commerce which provides the security of a digitally signed transaction using a mobile device 103. In one embodiment, the present disclosure describes a method of generating an image based on the transaction details and scanning the generated image on the mobile phone. The image contains encrypted transaction information that can be interpreted only by a valid mobile application. In addition, the captured image will populate itself into a signature generation screen of the mobile device 103 which will seek the customer input for PIN to generate the signature.

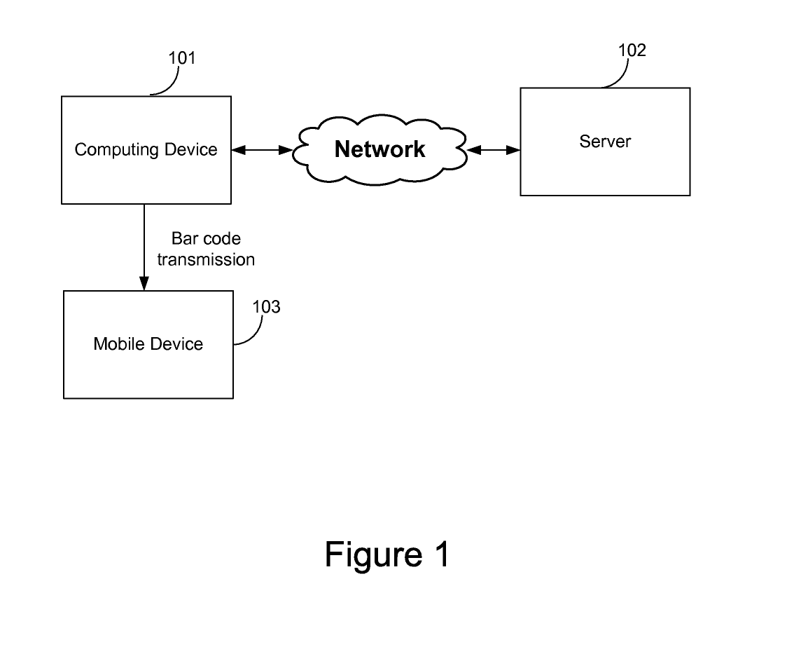

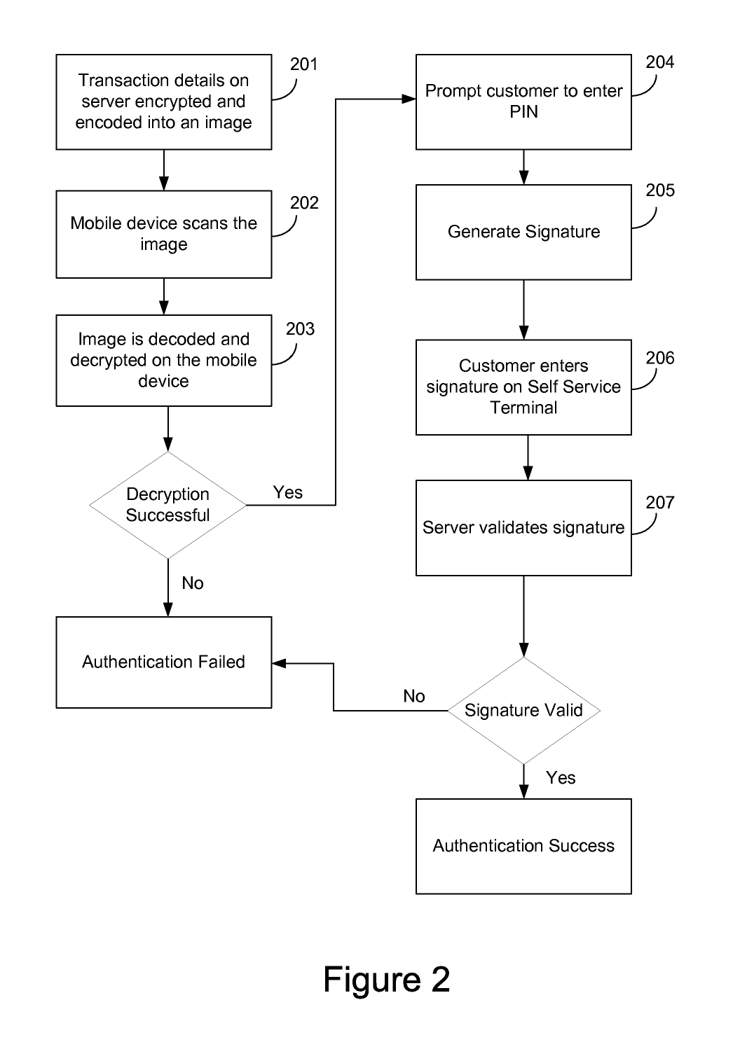

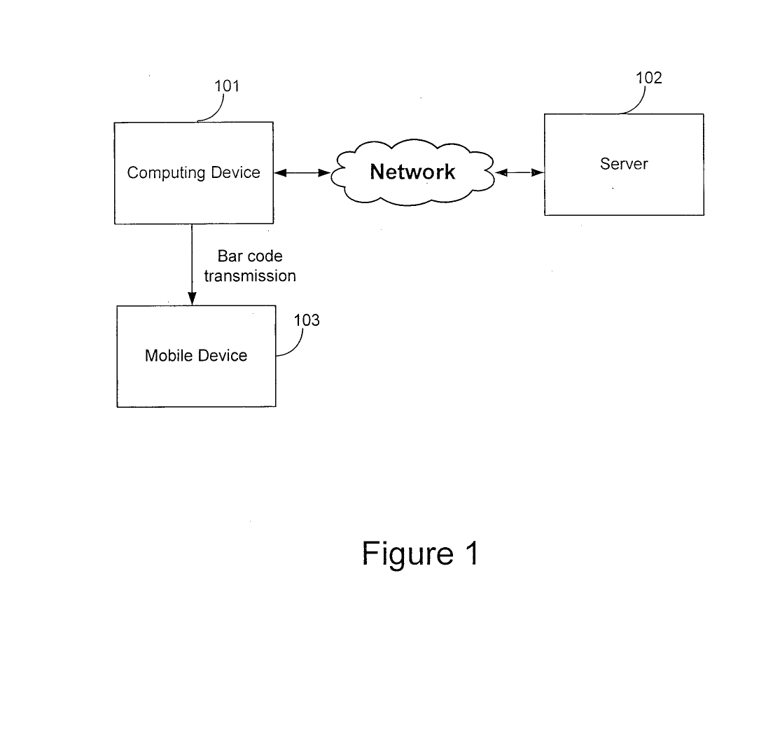

FIG. 1 is a block diagram of a system setup in accordance with an aspect of the subject disclosure for carrying out financial transactions securely. In the illustrated embodiment, exemplary system comprises a computing device 101, Server 102, a mobile device 103 and general purpose network. The computing device 101 includes but is not limiting to Automated Teller Machine (ATM), computer, mobile phone, Personal Digital Assistance (PDA), Point of Sale (POS) terminal, any device capable of doing e-banking and other related devices. In one embodiment, user carries out financial transaction using any one of the computing device 101 as listed above. The transaction information of the current transaction is forwarded to the server 102 over the network. The network may comprise a public network e.g., the Internet, World Wide Web, etc. or private network e.g., local area network (LAN), etc. or any combinations thereof e.g., a virtual private network, LAN connected to the Internet, etc. Furthermore, the network need not be a wired network only, and may comprise wireless network elements as known in the art.

In one embodiment, the server 102 receives the transaction information from the computing device 101 over the network. The server 102 encrypts the received transaction information using encryption technology know in art. For example, Symmetric encryption such as Digital Encryption standard (DES), and Asymmetric encryption or Public Key encryption such as RSA (Rivest Shamir Adleman) encryption. Depending on nature of the requirement, encryption algorithm is adapted for encrypting the information. Once encryption is done, encrypted information is encoded by the server 102. The information is encoded in a predetermined image pattern. The image pattern including but is not limiting to image with Bar code and QR code. The image is generated based on the nature of transaction details. The transaction information or transaction details are automatically captured by the server 102 to generate the image.

Further, the encoded image has to be transferred to mobile device 103 for generating One Time Password (OTP). The image can be transferred using any of the mobile communication networks. However there exists a problem in transferring the image over the network. It is known that mobile networks are prone to hacking Thus, it becomes easy for any hackers or person who intends to capture the transaction information to hack the network and access the account details of the account holders. In order to avoid such problems, the instant disclosure provides for by passing of the network to transfer the required information to the mobile device 103 for generating OTP. In the present disclosure, the image is transferred to the mobile device 103 bar code based transmission technique. In bar code based transmission technique, the image is scanned by a target source from any of the sources to capture the image with bar code onto the target source.

In one embodiment, the encoded image is transferred to the computing device 101 from where the transaction is originated. However, the encoded image can be transferred to other computing devices, if user request to do so. After the image is transferred to the computing device 101, the user scans the encoded image displayed on the computing device 101 from his mobile device 103 to capture the encoded image onto the mobile device 103. For example, the mobile device 103 includes but is not limiting to Mobile Phone, Personal Digital Assistants (PDA) and any other device which has a camera and capable of doing scanning The mobile device 103 with the help of an in-built camera and mobile application scans the image from the computing device 101 into to the mobile device 103. Thus, the instant technique disclosed in the present disclosure provides a novel and inventive way of communicating the transaction information from the enterprises system (computing device 101) to the mobile device 103 without depending on any mobile communication network. The transmission also provides additional layer of security by encrypting the image which can be decrypted only on a valid mobile application.

The mobile device 103 decodes the scanned image and later decrypts the decoded image to obtain transaction details. The encrypted transaction information can be decrypted and interpreted only by a valid mobile application. In addition, the captured image automatically populates itself into a signature generation screen of the mobile device 103. This screen requests the customer to input Personal Identification Number (PIN) issued by the competent authorities. For example, competent authorities include but are not limiting to Bank authority, and financial institutions. The mobile application uses the inputted PIN number with decrypted transaction information to generate the OTP. Only the valid mobile application implemented within the mobile device 103 is able to generate the OTP. It is known that the existing processes which are available provide features/facilities for generating a OTP based on transaction characteristic which are either entered by the user in the out of band device or transmitted to the mobile device 103 using a mobile communication network. Whereas the present disclosure neither requires the user to enter the transaction details on the mobile device 103 nor uses the mobile communication network to transmit the transaction details into the mobile device 103. Thus, additional layer of security is ensured.

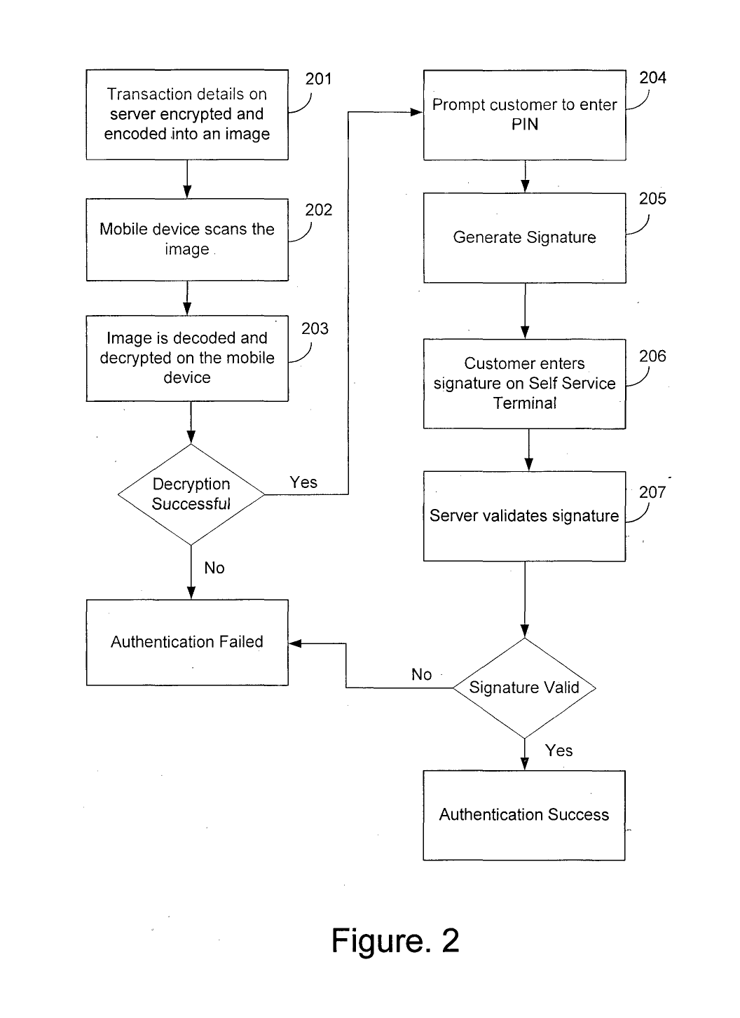

FIG. 2 is a flowchart illustrating a method for securing financial transaction, in accordance with an exemplary embodiment. The flow chart also illustrates generating One Time Password (OTP) using transaction information and predetermined user details.

At step 201, user conducts transaction in the computing device 101. The computing device 101 transmits the transaction information to the server 102. The server 102 encrypts the transaction details or transaction information. Further, the encrypted transaction information is encoded into a predetermined image pattern by the server 102. For example, the image pattern includes but is not limiting to image with a bar code and QR codes. The encoded image is transmitted to the computing device 101 for further processing.

At step 202, the mobile device 103 scans the image displayed on the computing device 101. At step 203, the scanned image is decoded and decrypted to retrieve the transaction information. As disclosed earlier, only valid mobile application can interpret the transaction information which is decoded and decrypted. If the decryption fails on the mobile device 103, then the device shows that the authentication has failed. For example, when the user tries to decrypt the decoded image using any mobile application other than the valid application which is implanted for decrypting the transaction information on the mobile device 103 then such decryption is unsuccessful. And the mobile device 103 shows that the decryption failed. This would provide addition layer of security in the financial transaction. If the decryption is successful, the transaction information is automatically populated into signature generation screen of the device for further processing.

At step 204, the signature generation screen prompts the user to enter the Personal Identification Number (PIN). Once the user enters the PIN on the screen, the mobile application generates the signature such as One Time Password (OTP) using both decrypted transaction information and PIN at step 205.

At step 206, the user enters the generated signature or OTP on self service terminals such as computing device 101 that include but is not limiting to computer, ATM, and PDA etc. The entered signature is transmitted to the server 102 for validation. At step 207, the server 102 validates the signature to authenticate the financial transaction. If the entered signature is not validated, then the server 102 sends the authentication failure information to the self service terminal.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for securing financial transaction comprising acts of:
encrypting transaction information on a server upon receipt of said information from a computing device;
encoding the encrypted transaction information into a predefined image pattern and transmitting the encoded image to the computing device;
scanning the image displayed on the computing device from user's mobile device to decode the scanned image and to decrypt the transaction information;
prompting the user upon successful decryption to enter Personal Identification Number (PIN) into the mobile device to generate an unique signature; and
entering the signature on the computing device for validation of said signature by the server for the secure financial transaction.

2. The method as claimed in claim 1, wherein the predefined image pattern is selected from at least one of bar code quick response (QR) code.

3. The method as claimed in claim 1, wherein the image is scanned using a camera of the mobile device.

4. The method as claimed in claim 1, wherein the encrypted transaction information is decrypted by a mobile application implemented within the mobile device.

5. The method as claimed in claim 1, wherein the scanned image populates itself onto signature generation screen of the mobile device to generate the signature.

6. The method as claimed in claim 1, wherein the signature is a One Time Password and a new password is generated for each transaction.

7. A system for securing financial transaction comprising:
a computing device for transmitting transaction information to a server and to receive the encoded image from the server;
the server being configured to encrypt the transaction information and to encode the encrypted information into a predefined image pattern; and
a mobile device capable of scanning the image displayed on the computing device, wherein said mobile device is configured to decode the scanned image and to decrypt the transaction information to generate an unique signature.

8. The system as claimed in claim 7, wherein a camera of the mobile device scans the image from the computing device.

9. The system as claimed in claim 7, wherein the mobile device comprises signature generation screen to display the scanned image and to prompt user to enter Personal Identification Number (PIN) to generate the unique signature.

10. The system as claimed in claim 9, wherein the mobile device comprises a mobile application to generate the signature using combination of transaction information decrypted from the image and the Personal identification Number (PIN) entered by the user.

11. The system as claimed in claim 7, wherein the server validates the signature entered by user on the computing device.

12. The system as claimed in claim 7, wherein the computing device is selected from at least one of Automated Teller Machine (ATM), computer, mobile phone, Personal Digital Assistance (PDA), Point of Sale (POS) terminal, any device capable of doing e-banking and other related devices.
